(19) United States
(12) Patent Application Publication
(10) Pub. No.: US 2013/0136292 A1
(43) Pub. Date: May 30, 2013

(54) MICROPHONE UNIT

(71) Applicants: Takeshi Inoda, Osaka (JP); Ryusuke Horibe, Osaka (JP); Fuminori Tanaka, Osaka (JP); Shuji Umeda, Osaka (JP)

(72) Inventors: Takeshi Inoda, Osaka (JP); Ryusuke Horibe, Osaka (JP); Fuminori Tanaka, Osaka (JP); Shuji Umeda, Osaka (JP)

(73) Assignee: FUNAI ELECTRIC CO., LTD., Daito-shi, Osaka (JP)

(21) Appl. No.: 13/813,206

(22) PCT Filed: Jul. 14, 2011
(86) PCT No.: PCT/JP2011/066057

§ 371 Date: Jan. 30, 2013

(30) Foreign Application Priority Data
Aug. 2, 2010 (JP) 2010-173288

(51) Int. Cl. H04R 1/04

(52) U.S. Cl. CPC H04R 1/04
USPC 381/355

(57) ABSTRACT

A microphone unit (1) includes: an electroacoustic conversion element (13) that converts a sound signal into an electrical signal based on vibration of a diaphragm (134); and an enclosure (10) that holds the electroacoustic conversion element (13). A first sound guide space (SP1) holding the electroacoustic conversion element (13) and a second sound guide space (SP2) separated by the diaphragm (134) from the first sound guide space (SP1) are provided in the enclosure. In an inward side of the second sound guide space (SP2) apart from the second opening (19), a cross-sectional area reduction portion (AR) is provided that locally reduces, as compared with forward and backward portions thereof, an area of a sound path cross section substantially perpendicular to a direction in which the sound wave travels.

### TECHNICAL FIELD

The present invention relates to a microphone unit that has the function of converting an input sound into an electrical signal and outputting it.

### BACKGROUND ART

Conventionally, for example, a microphone unit that has the function of converting an input sound into an electrical signal and outputting it is applied to sound communication devices such as a mobile telephone and a transceiver, information processing systems, such as a sound authentication system, that utilize a technology for analyzing an input sound, recording devices and the like; various microphone units are developed (for example, see patent documents 1 to 3).

Among conventional microphone units, as shown in, for example, patent documents 1 and 2, there is a microphone unit in which a diaphragm is vibrated by a difference between sound pressures applied to both sides thereof and thus a sound signal is converted into an electrical signal. In the following description, this type of microphone unit may be expressed as a differential microphone unit.

When a differential microphone unit is used as a close-talking microphone, the differential microphone unit can achieve excellent far noise suppression performance. Hence, for example, a differential microphone unit is useful such as for the applications of mobile telephones where a function as a close-talking microphone is required.

### RELATED ART DOCUMENT

### Patent Document

Patent document 1: JP-A-2009-188943
Patent document 2: JP-A-2005-295278
Patent document 3: JP-A-2008-219435

### DISCLOSURE OF THE INVENTION

### Problems to be Solved by the Invention

Incidentally, in a differential microphone unit, there are provided a first sound guide space that guides a sound wave from the outside to one surface (first surface) of a diaphragm and a second sound guide space that guides a sound wave from the outside to the other surface (the back surface opposite the first surface) of the diaphragm. In recent years, devices incorporating a microphone unit have tended to be reduced in size and thickness; the microphone unit is also significantly required to be reduced in size and thickness. Hence, in the differential microphone unit, as shown in, for example, patent documents 1 and 2, an opening making the first sound guide space communicate with the outside and an opening making the second sound guide space communicate with the outside are preferably provided in the same external surface of the enclosure of the microphone unit. By being configured as described above, the microphone unit can be reduced in size and thickness, and the configuration of a sound guide space (which is not the sound guide space of the microphone unit) provided within a device incorporating the microphone unit can be simplified (can be reduced in size and thickness).

However, when a differential microphone unit is configured as described above, it is difficult to make the first sound guide space and the second sound guide space have the same shape. When they cannot have the same shape, it is difficult to make them have the same frequency characteristic. The present applicant obtained findings that a frequency characteristic when a sound wave travels through the first sound guide space differs from a frequency characteristic when a sound wave travels through the second sound guide space, and thus it is disadvantageously impossible to obtain satisfactory far noise suppression performance in a wide frequency band. In other words, since, in the differential microphone unit whose size is designed to be reduced, it is disadvantageously impossible to obtain satisfactory far noise suppression performance in a wide frequency band, it is important to overcome this problem.

One way to overcome the above problem is that, as seen in the microphone unit of patent document 2, a sound resistance member is arranged in the first sound guide space and/or the second sound guide space to adjust the frequency characteristic. However, in the configuration where the sound resistance member (such as a felt) is used, for example, when, as an electroacoustic conversion element that converts a sound signal into an electrical signal based on the vibration of the diaphragm, a MEMS (micro electro mechanical system) chip is used, the electroacoustic conversion element is disadvantageously more likely to become defective by dust produced from the sound resistance member.

The microphone unit disclosed in patent document 3 is not a differential microphone unit. Since, in this microphone unit, a space facing one surface of a diaphragm and a space facing the other surface of the diaphragm are not required to have the same frequency characteristic, the problem described above is not encountered.

In view of the foregoing, an object of the present invention is to provide a high-quality microphone unit that can obtain satisfactory far noise suppression performance in a wide frequency band and that can be reduced in size.

### Means for Solving the Problem

To achieve the above object, according to the present invention, there is provided a microphone unit including: an electroacoustic conversion element that converts a sound signal into an electrical signal based on vibration of a diaphragm; and an enclosure that holds the electroacoustic conversion element, in which a first sound guide space holding the electroacoustic conversion element and a second sound guide space separated by the diaphragm from the first sound guide space are provided in the enclosure, the first sound guide space guides a sound wave from an outside to one surface of the diaphragm through a first opening formed in an external surface of the enclosure, the second sound guide space guides a sound wave from the outside to the other surface of the diaphragm through a second opening formed in the external surface of the enclosure and in an inward side of the second sound guide space apart from the second opening, a cross-sectional area reduction portion is provided that locally reduces, as compared with forward and backward portions thereof, an area of a sound path cross section substantially perpendicular to a direction in which the sound wave travels.

In the microphone unit configured as described above, a sound pressure can be applied to one surface of the diaphragm through the first sound guide space, and a sound pressure can be applied to the other surface of the diaphragm through the second sound guide space, with the result that the microphone unit function as a differential microphone unit. In the second sound guide space whose volume is generally low since the electroacoustic conversion element is not held, the cross-sectional area reduction portion for locally reducing the sound path cross-sectional area is provided. Thus, it is possible to make close to each other the frequency characteristic (resonance frequency) when the sound wave travels through the first sound guide space and the frequency characteristic (resonance frequency) when the sound wave travels through the second sound guide space. Consequently, with this configuration, it is possible to obtain a microphone unit having satisfactory far noise suppression performance in a wide frequency band. In this configuration, the structure of the enclosure is sophisticatedly designed to make close to each other the frequency characteristics when the sound wave travels through the two sound guide spaces. Hence, “a failure of the electroacoustic conversion element resulting from the generation of dust,” which is a fear produced when the frequency characteristics are made close to each other when the sound wave travels through the two sound guide spaces using a sound resistance member, is unlikely to occur.

Preferably, in the microphone unit configured as described above, the second sound guide space has a shape different from the shape of the first sound guide space, and the first opening and the second opening are formed in the same external surface of the enclosure. When, as in this configuration, the two sound guide spaces have different shapes, the far noise suppression performance of a differential microphone unit is more likely to be reduced by the difference between the frequency characteristics of the two sound guide spaces. However, with the effects produced by providing the cross-sectional area reduction portion described above, it is possible to obtain a microphone unit having satisfactory far noise suppression performance. Since, in this configuration, the first opening that makes the first sound guide space communicate with the outside and the second opening that makes the second sound guide space communicate with the outside are provided in the same external surface of the enclosure, this configuration is advantageous in reducing the size and thickness.

In the microphone unit configured as described above, the cross-sectional area reduction portion may be formed with a plurality of through holes. In this configuration, in the cross-sectional area reduction portion, it is possible to divide a region through which the sound wave cannot pass into a plurality of small regions and disperse them, and thus it is possible to easily obtain a high-performance microphone unit.

Preferably, in the microphone unit configured as described above, the enclosure includes a mounting portion on which the electroacoustic conversion element is mounted and a cover which is placed on the mounting portion to cover the electroacoustic conversion element, a first mounting portion opening covered by the electroacoustic conversion element mounted on the mounting portion, a second mounting portion opening formed in the same surface where the first mounting portion opening is formed and a mounting portion internal space connecting the first mounting portion opening and the second mounting portion opening are provided in the mounting portion, a holding space holding the electroacoustic conversion element placed on the mounting portion, a first through hole in which one end is connected to the holding space and the other end is connected to the outside and a second through hole which is not connected to the holding space and in which one end is connected to the second mounting portion opening and the other end is connected to the outside are provided in the cover, the first opening is obtained by the first through hole, and the second opening is obtained by the second through hole, the first sound guide space is formed with the first through hole and the holding space, the second sound guide space is formed with the second through hole, the first mounting portion opening, the second mounting portion opening and the mounting portion internal space and the cross-sectional area reduction portion is provided in the mounting portion. In this configuration, the structure of the differential microphone unit is not complicated, and thus it is possible to easily manufacture the differential microphone unit.

Preferably, in the microphone unit configured as described above, the second mounting portion opening is formed with a plurality of openings such that a total area of the plurality of openings is less than a cross-sectional area of the second through hole, and the cross-sectional area reduction portion is formed with a plurality of through holes forming the plurality of openings. In this configuration, the configuration of the second mounting portion opening provided in the mounting portion is simply adjusted, and thus it is possible to equalize the frequency characteristics when the sound wave travels through the two sound guide spaces and easily form the structure of the microphone unit having satisfactory far noise suppression performance in a wide frequency band.

Preferably, in the microphone unit configured as described above, within the first sound guide space, an electrical circuit portion that processes an electrical signal obtained from the electroacoustic conversion element is held. For example, although the electrical circuit portion can be provided outside the enclosure, in this configuration, the microphone unit can be more easily handled.

### Advantages of the Invention

According to the present invention, it is possible to provide a high-quality microphone unit that can obtain satisfactory far noise suppression performance in a wide frequency band and that can be reduced in size.

### BRIEF DESCRIPTION OF DRAWINGS

FIG. 1A A schematic perspective view showing the external configuration of a microphone unit according to a first embodiment;

FIG. 1B A cross-sectional view taken along position A-A of FIG. 1A;

FIG. 2A A top view of a first flat plate of a mounting portion included in the microphone unit of the first embodiment;

FIG. 2B A top view of a second flat plate of the mounting portion included in the microphone unit of the first embodiment;

FIG. 2C A top view of a third flat plate of the mounting portion included in the microphone unit of the first embodiment;

FIG. 3A A schematic plan view showing the configuration of a cover included in the microphone unit of the first embodiment; a view when the cover is seen from above;

FIG. 3B A schematic plan view showing the configuration of the cover included in the microphone unit of the first embodiment; a view when the cover is seen from below;

FIG. 4 A schematic cross-sectional view showing the configuration of a MEMS chip included in the microphone unit of the first embodiment;

FIG. 5 A block diagram showing the configuration of the microphone unit of the first embodiment;

FIG. 6 A schematic plan view when the mounting portion included in the microphone unit of the first embodiment is seen from above; a diagram showing a state where the MEMS chip and an ASIC are mounted;

FIG. 7 A graph showing a frequency characteristic when, in the microphone unit of the first embodiment, only either of a first sound guide space and a second sound guide space is used;

FIG. 8A A top view of a first flat plate of a mounting portion included in the microphone unit of a second embodiment;

FIG. 8B A top view of a second flat plate of the mounting portion included in the microphone unit of the second embodiment;

FIG. 8C A top view of a third flat plate of the mounting portion included in the microphone unit of the second embodiment;

FIG. 9 A cross-sectional view of the mounting portion included in the microphone unit of the second embodiment;

FIG. 10A A schematic perspective view showing the external configuration of a previously developed microphone unit;

FIG. 10B A cross-sectional view taken along position B-B of FIG. 10A;

FIG. 10C A schematic plan view when the mounting portion included in the previously developed microphone unit is seen from above;

FIG. 11 A graph showing the relationship between a sound pressure P and a distance R from a sound source;

FIG. 12 A diagram showing the directional characteristic of the previously developed microphone unit; and

FIG. 13 A graph showing a frequency characteristic when, in the previously developed microphone unit, only either of a first sound guide space and a second sound guide space is used.

### DESCRIPTION OF EMBODIMENTS

Embodiments of a microphone unit to which the present invention is applied will be described in detail below with reference to accompanying drawings. For ease of understanding of the present invention, the configuration and the problem of a microphone unit (hereinafter referred to as a previously developed microphone unit) previously developed by the present applicant will first be described.

(Previously Developed Microphone Unit)

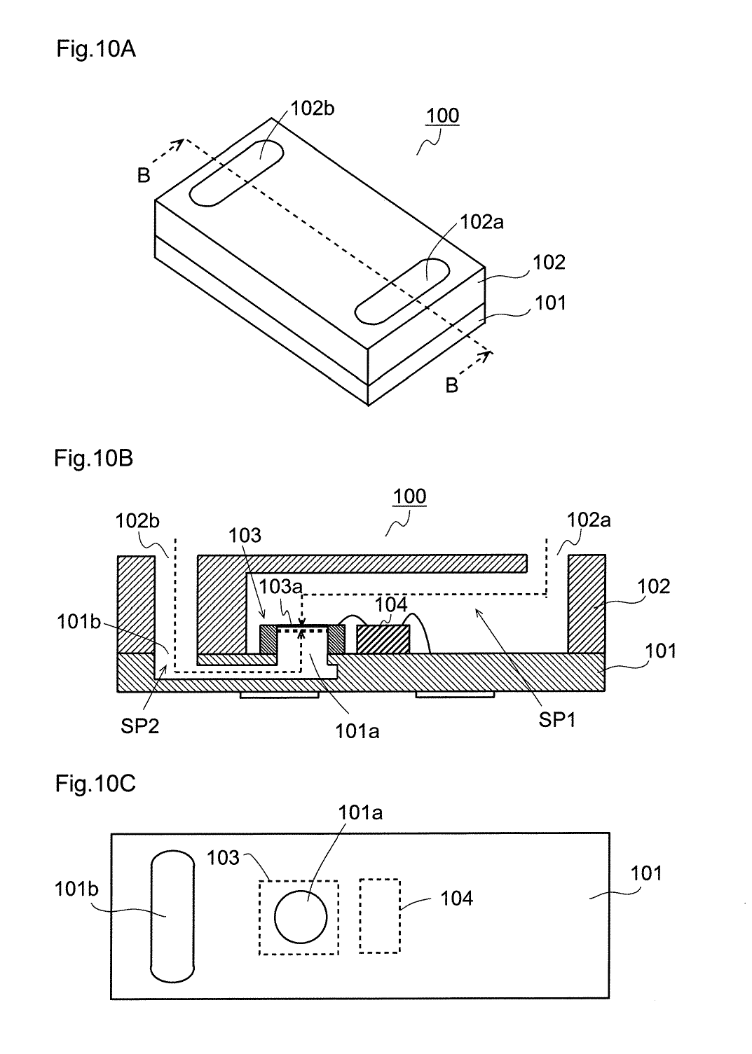

FIGS. 10A, 10B and 10C are diagrams showing the previously developed microphone unit; FIG. 10A is a schematic perspective view showing the external configuration; FIG. 10B is a cross-sectional view taken along position B-B of FIG. 10A; FIG. 10C is a schematic plan view when a mounting portion included in the previously developed microphone unit is seen from above. In FIG. 10C, members mounted on the mounting portion are represented by broken lines.

As shown in FIGS. 10A, 10B and 10C, the previously developed microphone unit 100 is configured to hold, within an enclosure formed with the mounting portion 101 and a cover 102 substantially in the shape of a rectangular parallelepiped, a MEMS (micro electro mechanical system) chip 103 and an ASIC (application specific integrated circuit) 104. The MEMS chip 103 has a diaphragm 103a, and functions as an electroacoustic conversion element to convert a sound signal into an electrical signal based on the vibration of the diaphragm 103a. The ASIC 104 performs amplification processing on the electrical signal taken out of the MEMS chip 103.

In the upper surface of the mounting portion 101 of the enclosure of the microphone unit 100, a substantially circular first mounting portion opening 101a and a substantially rectangular (substantially stadium-shaped) second mounting portion opening 101b are provided. The MEMS chip 103 is mounted on the mounting portion 101 so as to cove the first mounting portion opening 101a.

In the upper surface of the cover 102 of the enclosure of the microphone unit 100, two openings 102a and 102b are provided that have the same shape (which can be said to be substantially rectangular or substantially stadium-shaped) and that have the same area. The first opening 102a is arranged close to one end portion of the microphone unit 100 in the longitudinal direction, and the second opening 102b is arranged close to the other end portion of the microphone unit 100 in the longitudinal direction; both openings are arranged symmetrically with respect to the center of the microphone unit 100.

Within the enclosure formed with the mounting portion 101 and the cover 102, as shown in FIG. 10B, a first sound guide space SP1 that guides, through the first opening 102a, a sound wave from the outside to the upper surface of the diaphragm 103a of the MEMS chip 103 and a second sound guide space SP2 that guides, through the second opening 102b, a sound wave from the outside to the lower surface of the diaphragm 103a of the MEMS chip 103 are formed. In other words, the microphone unit 100 is configured as a differential microphone unit.

The MEMS chip 103 and the ASIC 104 are arranged within the first sound guide space SP1. The MEMS chip 103 is arranged in the first sound guide space SP1, and thus the first sound guide space SP1 and the second sound guide space SP2 are separated. In the microphone unit 100, the distance over which an external sound travels from the first opening 102a to the upper surface of the diaphragm 103a and the distance over which an external sound travels from the second opening 102b to the lower surface of the diaphragm 103a are provided such that the distances are substantially equal to each other, with the result that the time period during which the external sound travels from the first opening 102a to the upper surface of the diaphragm 103a is equal to the time period during which the external sound travels from the second opening 102b to the lower surface of the diaphragm 103a.

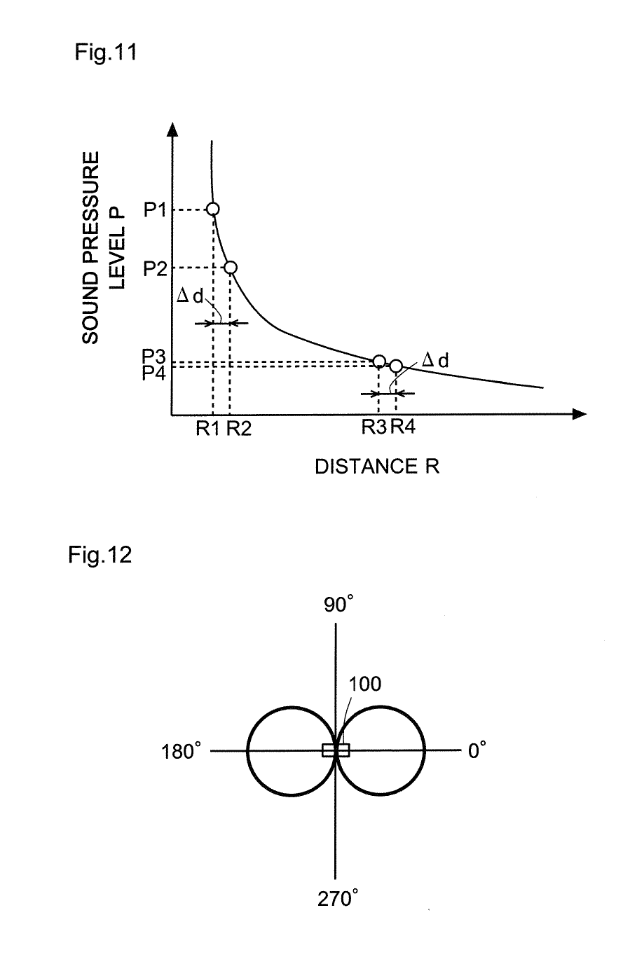

The characteristic of the previously developed microphone unit 100 configured as described above will be described. Before the description, the properties of a sound wave will be described. FIG. 11 is a graph showing the relationship between a sound pressure P and a distance R from a sound source. As shown in FIG. 11, as the sound wave travels through a medium such as air, the sound wave is attenuated, and the sound pressure (the intensity and the amplitude of the sound wave) is decreased. The sound pressure is inversely proportional to the distance from the sound source; the relationship between the sound pressure P and the distance R can be expressed as formula (1) below. In formula (1), k is a proportional constant.

P=k/R (1)

As is obvious from FIG. 11 and formula (1), the sound pressure is rapidly attenuated (the left side of the graph) in a position where the sound pressure is close to the sound source whereas the sound pressure is gradually attenuated (the right side of the graph) as the sound pressure moves away from the sound source. Specifically, the sound pressure that is transmitted between two positions (R1 and R2 or R3 and R4) where the difference between distances from the sound source is only Δd is significantly attenuated (P1-P2) from R1 to R2 which are close to the sound source whereas the sound pressure is only slightly attenuated (P3-P4) from R3 to R4 which are far from the sound source.

FIG. 12 is a diagram showing the directional characteristic of the previously developed microphone unit. In FIG. 12, the posture of the microphone unit 100 is assumed to be the same as shown in FIG. 10B. If the distance between the sound source and the microphone unit 100 is constant, when the sound source is in the direction of 0° or 180° in FIG. 12, the sound pressure applied to the diaphragm 103a is highest. This is because the difference between the distance over which the sound wave emitted from the sound source travels through the first opening 102a to the upper surface of the diaphragm 103a and the distance over which the sound wave emitted from the sound source travels through the second opening 102b to the lower surface of the diaphragm 103a is greatest. When the sound source is in the direction of 90° or 270° in FIG. 12, the sound pressure applied to the diaphragm 103a is minimized (substantially zero). This is because the difference between the distance over which the sound wave emitted from the sound source travels through the first opening 102a to the upper surface of the diaphragm 103a and the distance over which the sound wave emitted from the sound source travels through the second mounting surface 102b to the lower surface of the diaphragm 103a is substantially zero.

In other words, as shown in FIG. 12, the microphone unit 100 functions as a bidirectional microphone unit that is highly sensitive to a sound wave incoming from the direction of 0° or 180° and is poorly sensitive to a sound wave incoming from the direction of 90° or 270°.

The characteristic of the microphone unit 100 will now be described with the assumption that the microphone unit 100 is used as a close-talking microphone.

The sound pressure of a target sound emitted in the vicinity of the microphone unit 100 is significantly attenuated between the first opening 102a and the second opening 102b. Hence, a large difference between the sound pressure transmitted to the upper surface of the diaphragm 103a and the sound pressure transmitted to the lower surface of the diaphragm 103a is produced. On the other hand, the sound source of background noise is far as compared with the target sound, and the background noise is little attenuated between the first opening 102a and the second opening 102b. Hence, the difference between the sound pressure transmitted to the upper surface of the diaphragm 103a and the sound pressure transmitted to the lower surface of the diaphragm 103a is significantly reduced.

Since the sound pressure difference of the background noise received by the diaphragm 103a is extremely small, almost all of the sound pressure of the background noise is cancelled out in the diaphragm 103a. By contrast, since the sound pressure difference of the above-described target sound received by the diaphragm 103a is large, the sound pressure of the target sound is not cancelled out in the diaphragm 103a. Hence, a signal obtained by the vibration of the diaphragm 103a can be regarded as a signal of the target sound obtained by removing the background noise. In other words, when the microphone unit 100 is used as a close-talking microphone, the microphone unit 100 achieves excellent far noise suppression performance.

However, the present applicant obtains findings that the previously developed microphone unit 100 has the following problem. This problem will be described below.

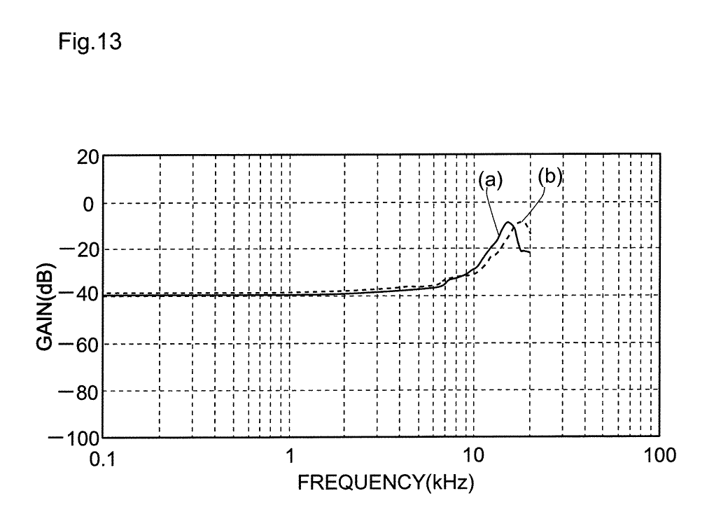

FIG. 13 is a graph showing a frequency characteristic when, in the previously developed microphone unit, only either the first sound guide space or the second sound guide space is used. In FIG. 13, the horizontal axis (logarithmic axis) is the frequency, and the vertical axis is the output of the microphone. In FIG. 13, a graph (a) represented by a solid line indicates a frequency characteristic when a sound wave is incoming from only the first opening 102a of the microphone unit 100 (that is, when only the first sound guide space SP1 is used). In FIG. 13, a graph (b) represented by a broken line indicates a frequency characteristic when a sound wave is incoming from only the second opening 102b of the microphone unit 100 (that is, when only the second sound guide space SP2 is used).

When the data in FIG. 13 is obtained, the position of the sound source is a constant position in the direction of 180° in FIG. 12. When the data on each frequency is obtained, the sound pressure of the sound wave emitted from the sound source is constant.

The microphone unit 100 is naturally required to achieve satisfactory far noise suppression performance in all frequencies within a usage frequency range (for example, 100 Hz to 10 kHz). The far noise suppression performance is closely related to the bidirectivity described above. In order to obtain the satisfactory far noise suppression performance within the usage frequency range, the microphone unit 100 is required to achieve bidirectivity as shown in FIG. 12 in all frequencies within the usage frequency range.

In other words, when a sound wave is made to enter the microphone unit 100 from the sound source arranged in the direction of 180° in FIG. 12, it is required to maintain, within the usage frequency range, a constant output difference in the graphs (a) and (b) of FIG. 13 even if the frequency is changed. The constant output difference is produced because the distance from the sound source to the first opening 102a differs the distance from the sound source to the second opening 102b.

The experimental result shown in FIG. 13 shows that the graphs (a) and (b) maintain a constant output difference in about frequencies of 100 Hz to 7 kHz. However, when the frequency exceeds about 7 kHz, the output difference described above does not remain constant; when the frequency exceeds 8 kHz, which one of the output values of graphs (a) and (b) is higher than the other is reversed. Specifically, in the previously developed microphone unit 100, since the balance between the frequency characteristic when the sound wave travels through the first sound guide space SP1 and the frequency characteristic when the sound wave travels through the second sound guide space SP2 is lost in a high-frequency band, the target bidirectivity cannot be obtained, with the result that it is disadvantageously impossible to obtain satisfactory far noise suppression performance.

In order to, for example, easily reduce the size and thickness of a device (such as a mobile telephone, which has a sound input function) incorporating the microphone unit 100, in the microphone unit 100, the first opening 102a for guiding the external sound to the upper surface of the diaphragm 103a and the second opening 102b for guiding the external sound to the lower surface of the diaphragm 103a are provided in the same surface (the upper surface of the cover 102). However, in order for the configuration described above to be adopted, in the microphone unit 100, the first sound guide space SP1 inevitably differs in shape from the second sound guide space SP2.

The MEMS chip 103 (as well as the ASIC, when the ASIC is held within the enclosure as a separate member) held within the enclosure needs to be held in either the sound guide space SP1 or SP2, and thus it is difficult to make the volumes of the two sound guide spaces equal to each other. In the microphone unit 100, the MEMS chip 103 is held in the first sound guide space SP1, and the volume of the first sound guide space SP1 is larger than that of the second sound guide space SP2.

Because of the unbalance of the shapes of the first sound guide space SP1 and the second sound guide space SP2 described above, the two sound guide spaces SP1 and SP2 probably have different frequency characteristics. This probably causes the above problem in which it is impossible to obtain satisfactory far noise suppression performance in high frequencies.

The present invention is designed to overcome the above problem by modifying the structure of the previously developed microphone unit such that the frequency characteristics of the first sound guide space SP1 and the second sound guide space SP2 described above are equalized (made close to each other). One method to equalize the frequency characteristics when the sound waves travelling through the two sound guide spaces SP1 and SP2 is to use a sound resistance member. However, since the sound resistance member is generally formed of a felt or the like, there is a fear that, for example, dust will enter the MEMS chip 103. Hence, in order for the problem of dust as described above to be prevented, in the present invention, the frequency characteristics when the sound waves travelling through the two sound guide spaces SP1 and SP2 are equalized by modifying the structure of the microphone unit 100.

(Microphone Unit According to a First Embodiment of the Present Invention)

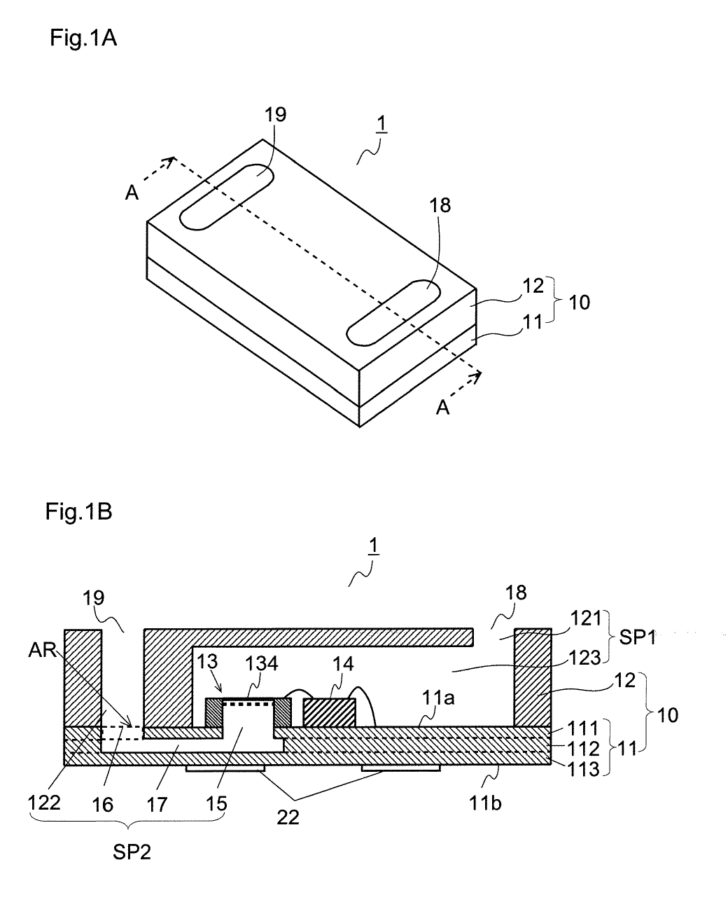

FIGS. 1A and 1B are diagrams showing the configuration of a microphone unit according to a first embodiment; FIG. 1A is a schematic perspective view showing the external configuration; FIG. 1B is a cross-sectional view taken along position A-A of FIG. 1A. As shown in FIGS. 1A and 1B, the microphone unit 1 of the first embodiment includes a mounting portion 11 on which a MEMS chip 13 and an ASIC 14 are mounted and a cover 12 that is mounted on the mounting portion 11 to cover the MEMS chip 13 and the ASIC 14. The mounting portion 11 and the cover 12 constitute the enclosure 10 of the microphone unit 1; the enclosure 10 is formed substantially in the shape of a rectangular parallelepiped.

In the present embodiment, the length of the enclosure 10 in the longitudinal direction (corresponding to the left/right direction of FIG. 1B) is 7 mm, the length in the widthwise direction (corresponding to a direction perpendicular to the plane of FIG. 1B) is 4 mm and the length in the thickness direction (corresponding to the up/down direction of FIG. 1B) is 1.5 mm. However, the size mentioned above is simply an example; naturally, the size of the microphone unit according to the present invention is not limited to this size. Although, in the following description, the size is disclosed, the size is simply an example.

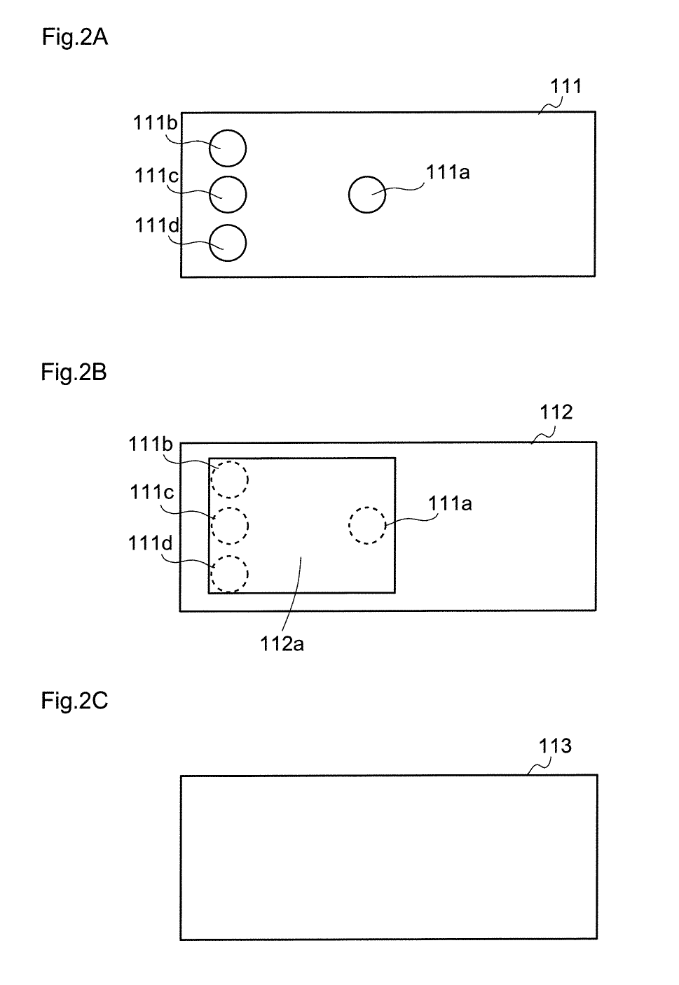

The mounting portion 11 is, as shown in FIG. 1B, formed by stacking a third flat plate 113, a second flat plate 112 and a first flat plate 111 in this order from bottom to top. The individual flat plates are joined with, for example, an adhesive or an adhesive sheet. FIGS. 2A, 2B and 2C are schematic plan views showing the three flat plates constituting the mounting portion included in the microphone unit of the first embodiment; FIG. 2A is a top view of the first flat plate; FIG. 2B is a top view of the second flat plate; FIG. 2C is a top view of the third flat plate.

As shown in FIGS. 2A, 2B and 2C, the three flat plates 111, 112 and 113 constituting the mounting portion 11 each are formed substantially in the shape of a rectangle as seen in plan view, and the three flat plates have substantially the same sizes in length and width and substantially the same size in thickness. In the present embodiment, the length of each flat plate in the longitudinal direction (left/right direction) is 7 mm, the length in the widthwise direction (up/down direction) is 4 mm and the thickness is 0.2 mm. Although the material of the flat plates 111 to 113 constituting the mounting portion 11 is not particularly limited, a known material used as a substrate material is preferably used, and, for example, FR-4, a ceramic or a polyimide film is used.

In the first flat plate 111, as shown in FIG. 2A, a through hole 111a formed substantially in the shape of a circle as seen in plan view is provided in the vicinity of the center thereof (to be exact, in a position slightly displaced to one side (the left side of FIG. 2A) in the longitudinal direction). In the first flat plate 111, three through holes 111b, 111c and 111d that are aligned a predetermined distance apart in the widthwise direction (corresponding to the up/down direction of FIG. 2A) and that are formed substantially in the shape of a circle as seen in plan view are provided close to one end (close to the left end of FIG. 2A) in the longitudinal direction. The three through holes 111b to 111d are formed such that their centers are arranged on one straight line parallel to the widthwise direction. In the present embodiment, the diameter of each of the through holes 111a to 111d as seen in cross section is 0.5 mm.

In the second flat plate 112, as shown in FIG. 2B, a through hole 112a (whose upper surface and lower surface have the same shape and size) formed substantially in the shape of a rectangle as seen in plan view is provided. The through hole 112a formed substantially in the shape of a rectangle as seen in plan view is provided such that, with the second flat plate 112 and the first flat plate 111 stacked, the four through holes 111a to 111d provided in the first flat plate 111 fall within the region thereof. For ease of understanding of the relationship between the first flat plate 111 and the second flat plate 112, in FIG. 2B, the four through holes 111a to 111d provide in the first flat plate 111 are represented by broken lines.

The third flat plate 113 is, as shown in FIG. 2C, a flat plate in which no through hole is formed. The first flat plate 111, the second flat plate 112 and the third flat plate 113 configured as described above are adhered, and thus it is possible to obtain the mounting portion 11 in which a first mounting portion opening 15 obtained by the through hole 111a, three second mounting portion openings 16 obtained by the three through holes 111b, 111c and 111d and a mounting portion internal space 17 that connects the first mounting portion opening 15 and the second mounting portion openings 16 (three openings) are formed (see FIG. 1B).

Electrode pads and electrical wiring are formed on the mounting portion 11; they will be described later. Although, in the present embodiment, the mounting portion 11 is obtained by adhering the three flat plates, the configuration of the mounting portion 11 is not limited to this configuration. The mounting portion 11 may be formed with one flat plate or may be formed with a plurality of flat plates other than the three flat plates. The shape of the mounting portion 11 is not limited to the shape of a plate. When the mounting portion 11 that is not plate-shaped is formed with a plurality of members, a member that is not a flat plate may be included in the members constituting the mounting portion 11. Furthermore, the shapes of the first mounting portion opening 15, the second mounting portion openings 16 (three openings) and the mounting portion internal space 17 formed in the mounting portion 11 are not limited to the configuration of the present embodiment. The shapes may be changed as necessary.

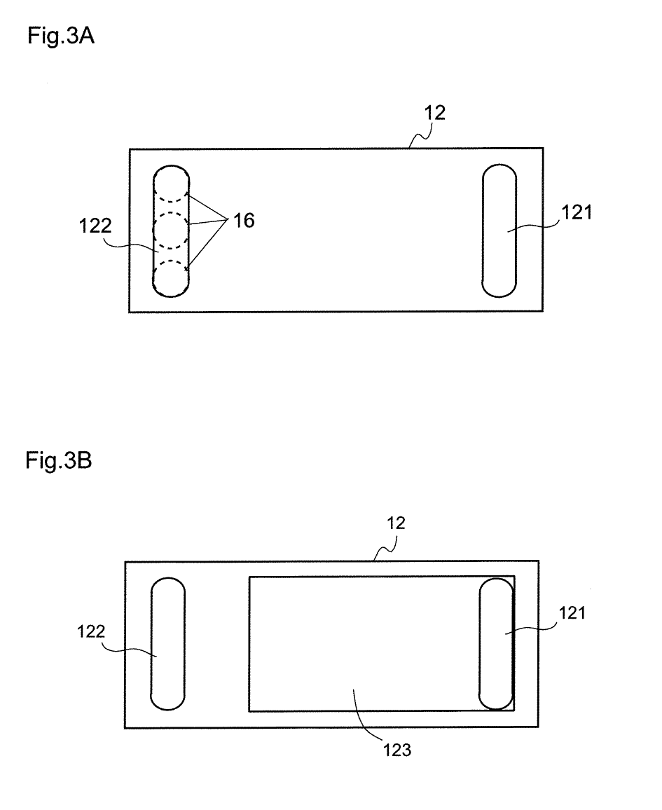

FIGS. 3A and 3B are schematic plan views showing the configuration of the cover included in the microphone unit of the first embodiment; FIG. 3A shows a state where the cover is seen from above; FIG. 3B shows a state where the cover is seen from below. The external shape of the cover 12 is formed substantially in the shape of a rectangular parallelepiped (also see FIG. 1A). The lengths of the cover 12 in the longitudinal direction (the left/right direction in FIGS. 3A and 3B) and in the widthwise direction (the up/down direction in FIGS. 3A and 3B) are respectively the same as those in the longitudinal direction and in the widthwise direction of the mounting portion 11. Specifically, in the present embodiment, the length in the longitudinal direction is 7 mm, and the length in the widthwise direction is 4 mm. The thickness of the cover 12 is 0.9 mm.

As shown FIGS. 3A and 3B, in the cover 12, one through hole 121 (an example of a first through hole according to the present invention) formed substantially in the shape of a rectangle as seen in plan view (substantially stadium-shaped) is provided in one end side in the longitudinal direction (the right side of FIGS. 3A and 3B). One through hole 122 (an example of a second through hole according to the present invention) having the same shape and size as the through hole 121 is provided in the other end side (the right side of the FIGS. 3A and 3B) of the cover 12. The two through holes 121 and 122 are arranged substantially symmetrically with respect to the center of the cover 122. In the cross sections of the two through holes 121 and 122, the length in the longitudinal direction (the up/down direction of FIGS. 3A and 3B) is 2 mm, and the length in the widthwise direction (the left/right direction of FIGS. 3A and 3B) is 0.5 mm.

The position of the through hole 122 is adjusted such that, with the cover 12 placed on the mounting portion 11, one end (lower end) of the through hole 122 overlaps (is connected to) the three second mounting portion openings 16 (see FIG. 1B) formed in the mounting portion 11. For ease of understanding of the relationship between the through hole 122 and the second mounting portion openings 16 when the cover 12 is placed on the mounting portion 11, in FIG. 3A, the three second mounting portion openings 16 formed in the mounting portion 11 are represented by broken lines.

The through hole 121 provided in the one end side of the cover 12 and the through hole 122 provided in the other end side of the cover 12 are preferably formed such that the distance between the centers thereof is equal to or greater than 4 mm but is equal to or less than 6 mm. As will be described later, these through holes 121 and 122 are used as the input portions of the sound waves. When the distance between the centers is excessively increased, the phase difference of the sound waves reaching the upper surface and the lower surface of a diaphragm 134 (included in the MEMS chip 13) is increased, and thus the microphone characteristic is degraded (the noise suppression performance is degraded). In order to prevent the foregoing conditions, the distance between the centers is preferably 6 mm or less. When the distance between the centers is excessively decreased, the difference between sound pressures applied to the upper surface and the lower surface of the diaphragm 134 is decreased, and the amplitude of the diaphragm 134 is decreased, with the result that the SNR (signal to noise ratio) of an electrical signal output from the ASIC 14 is degraded. In order to prevent the foregoing conditions, the distance between the centers is preferably 4 mm or more.

When seen from below, in the cover 12, a concave portion 123 (in the present embodiment, its depth is 0.7 mm) formed substantially in the shape of a rectangle as seen in plan view is formed. The concave portion 123 is provided so as to cover the through hole 121 provided in the one end side (the right end side of FIG. 3B) of the cover 12 in the longitudinal direction; the concave portion 123 is connected to the through hole 121. On the other hand, the concave portion 123 is provided so as not to cover the through hole 122 provided in the other end side (the left end side of FIG. 3B) of the cover 12 in the longitudinal direction. In other words, the concave portion 123 is not connected to the through hole 122.

The material of the cover 12 can be a resin such as an LCP (liquid crystal polymer) or a PPS (polyphenylene sulfide). In order to make the resin electrically conductive, a metal filer such as a stainless steel or a carbon may be mixed with and contained in the resin of the cover 12. The material of the cover 12 may be a substrate material such as FR-4 or a ceramic.

The MEMS chip 13 mounted on the mounting portion 11 is an example of an electroacoustic conversion element according to the present invention that converts a sound signal into an electrical signal based on the vibration of the diaphragm. The MEMS chip 13 formed with a silicon chip is a small capacitor microphone chip that is manufactured with a semiconductor manufacturing technology.

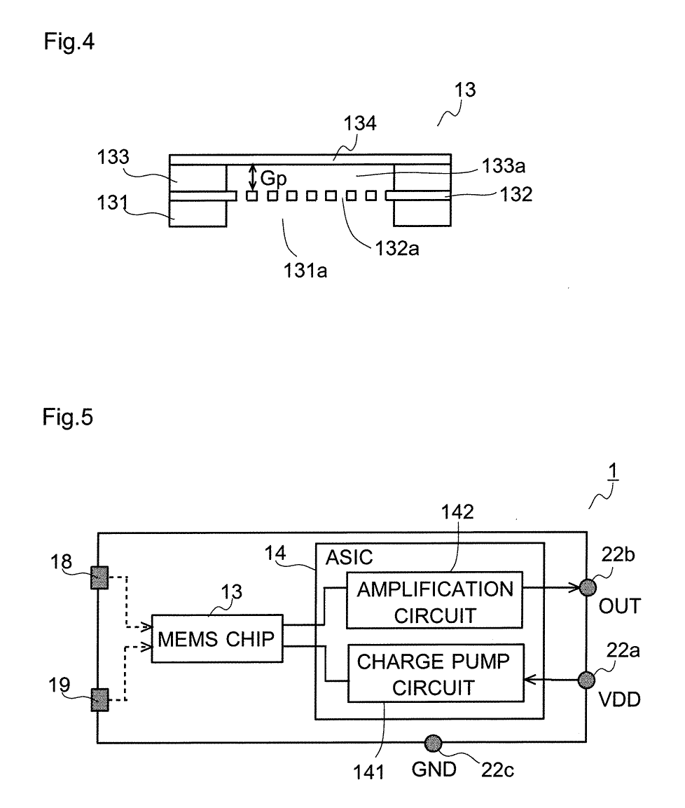

FIG. 4 is a schematic cross-sectional view showing the configuration of the MEMS chip included in the microphone unit of the first embodiment. As shown in FIG. 4, the external shape of the MEMS chip 13 is formed substantially in the shape of a rectangular parallelepiped, and the MEMS chip 13 includes an insulating base substrate 131, a fixed electrode 132, an insulating intermediate substrate 133 and the diaphragm 134.

In the center portion of the base substrate 131, the through hole 131a formed substantially in the shape of a circle as seen in plan view is formed. The plate-shaped fixed electrode 132 is arranged on the base substrate 131; a plurality of through holes 132a having a small diameter (diameter of about 10 μm) are formed. The intermediate substrate 133 is arranged on the fixed electrode 132; as with the base substrate 131, in the center portion thereof, the through hole 133a formed substantially in the shape of a circle as seen in plan view is formed. The diaphragm 134 arranged on the intermediate substrate 133 is a thin film that receives the sound pressure to vibrate (vibrate in the up/down direction of FIG. 4; in the present embodiment, the portion formed substantially in the shape of a circle vibrates), is conductive and forms one end of the electrode. The fixed electrode 132 and the diaphragm 134 which are arranged opposite each other such that they are made substantially parallel to each other by the presence of the intermediate substrate 133 with a gap Gp therebetween form a capacitor.

In the capacitor formed with the fixed electrode 132 and the diaphragm 134, when the diaphragm 134 is vibrated by the arrival of the sound wave, its capacitance is changed due to variations in the distance between the electrodes. Consequently, it is possible to take out the sound wave (sound signal) entering the MEMS chip 13 as an electrical signal. In the MEMS chip 13, the lower surface side of the diaphragm 134 is also made to communicate with an external space (the outside of the MEMS chip 13) by the presence of the through hole 131a formed in the base substrate 131, a plurality of through holes 132a formed in the fixed electrode 132 and the through hole 133a formed in the intermediate substrate 133.

The configuration of the MEMS chip 13 is not limited to the configuration of the present embodiment; the configuration may be changed as necessary. For example, although, in the present embodiment, the diaphragm 134 is higher than the fixed electrode 132, the MEMS chip may be configured such that the opposite relationship (where the diaphragm is lower than the fixed electrode) holds true.

The ASIC 14 is an integrated circuit that performs amplification processing on the electrical signal taken out based on variations (derived from the vibration of the diaphragm 134) in the capacitance of the MEMS chip 13. The ASIC 14 is an example of an electrical circuit portion according to the present invention. As shown in FIG. 5, the ASIC 14 includes a charge pump circuit 141 that applies a bias voltage to the MEMS chip 13. The charge pump circuit 141 steps up a power supply voltage VDD (for example, about 1.5 to 3 volts to about 6 to 10 volts), and applies the bias voltage to the MEMS chip 13. The ASIC 14 also includes an amplification circuit 142 that detects variations in the capacitance of the MEMS chip 13. An electrical signal amplified by the amplification circuit 142 is output from the ASIC 14. FIG. 5 is a block diagram showing the configuration of the microphone unit according to the first embodiment.

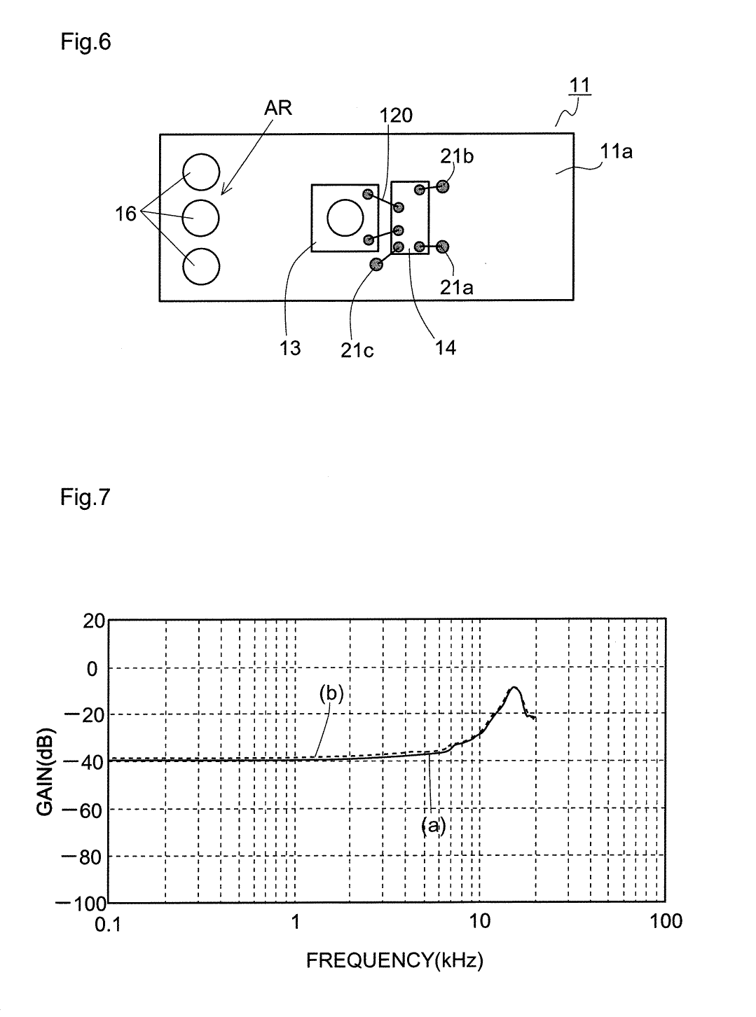

The positional relationship and the electrical connection relationship between the MEMS chip 13 and the ASIC 14 in the microphone unit 1 will now be described mainly with reference to FIG. 6. FIG. 6 is a schematic plan view when the mounting portion included in the microphone unit of the first embodiment is seen from above, and is a diagram showing a state where the MEMS chip and the ASIC are mounted.

The MEMS chip 13 is mounted on the mounting portion 11 such that the diaphragm 134 is substantially parallel to the upper surface (mounting surface) 11a of the mounting portion 11 (see FIG. 1B). The MEMS chip 13 is mounted on the mounting portion 11 so as to cover the first mounting portion opening 15 (see FIG. 1B) formed on the upper surface 11a of the mounting portion 11. The ASIC 14 is arranged to be adjacent to the MEMS chip 13.

The MEMS chip 13 and the ASIC 14 are mounted on the mounting portion 11 by die bonding and wire bonding. Specifically, the MEMS chip 13 is joined on the upper surface 11a of the mounting portion 11 by an unillustrated die bonding member (for example, an adhesive of an epoxy resin or a silicone resin) such that no gap is formed between the bottom surface thereof and the upper surface 11a of the mounting portion 11. The MEMS chip 13 is joined in this way, and thus a sound is prevented from being leaked in through the gap formed between the upper surface 11a of the mounting portion 11 and the bottom surface of the MEMS chip 13. As shown in FIG. 6, the MEMS chip 13 is electrically connected to the ASIC 14 with wires 20 (preferably, gold wires).

In the ASIC 14, the bottom surface opposite the upper surface 11a of the mounting portion 11 is joined on the upper surface 11a of the mounting portion 11 by the unillustrated die bonding member. As shown in FIG. 6, the ASIC 14 is electrically connected, with the wires 20, to a plurality of electrode terminals 21a, 21b and 21c formed on the upper surface 11a of the mounting portion 11. The electrode terminal 21a is a power supply terminal for input of the power supply voltage (VDD); the electrode terminal 21b is an output terminal that outputs the electrical signal on which the amplification processing has been performed in the amplification circuit 142 of the ASIC 14; the electrode terminal 21c is a GND terminal for ground connection.

As shown in FIG. 1B, external connection electrode pads 22 are formed on the bottom surface (the back surface of the mounting surface 11a) of the mounting portion 11. The external connection electrode pads 22 include a power supply electrode pad 22a, an output electrode pad 22b and a GND electrode pad 22c (see FIG. 5). The power supply terminal 21a provided on the upper surface 11a of the mounting portion 11 is electrically connected to the power supply electrode pad 22a through unillustrated wiring (including penetration wiring) formed in the mounting portion 11. The output terminal 21b provided on the upper surface 11a of the mounting portion 11 is electrically connected to the output electrode pad 22b through unillustrated wiring (including penetration wiring) formed in the mounting portion 11. The GND terminal 21c provided on the upper surface 11a of the mounting portion 11 is electrically connected to the GND electrode pad 20c through unillustrated wiring (including penetration wiring) formed in the mounting portion 11. The penetration wiring can be formed by a through-hole via that is commonly used in substrate manufacturing.

Although, in the present embodiment, the MEMS chip 13 and the ASIC 14 are mounted by wire bonding, it is needless to say that the MEMS chip 13 and the ASIC 14 are flip-chip mounted. In this case, electrodes are formed on the lower surface of the MEMS chip 13 and the ASIC 14, the corresponding electrode pads are arranged on the upper surface of the mounting portion 11 and the connection of these are performed by a wiring pattern formed on the mounting portion 11.

On the mounting portion 11 on which the MEMS chip 13 and the ASIC 14 are mounted, the cover 12 is placed such that the concave portion 123 holds the MEMS chip 13 and the ASIC 14. Then, when the mounting portion 11 and the cover 12 are joined so as to be hermetically sealed (for example, with an adhesive or an adhesive sheet), the microphone unit 1 incorporating the MEMS chip 13 and the ASIC 14 within the enclosure 10 can be obtained.

Within the enclosure 10 of the microphone unit 1, as shown in FIG. 1B, the first sound guide space SP1 is formed with the through hole 121 provided in the cover 12 and the holding space (concave portion) 123 and guides a sound wave from the outside to the upper surface of the diaphragm 134 through a first opening 18 (obtained by the through hole 121). Within the enclosure 10, the second sound guide space SP2 is formed with the through hole 122 provided in the cover 12, the first mounting portion opening 15 provided in the mounting portion 11, the three second mounting portion openings 16 and the mounting portion internal space 17 and guides a sound wave from the outside to the lower surface of the diaphragm 134 through a second opening 19 (obtained by the through hole 122). The first sound guide space SP1 and the second sound guide space SP2 are separated by the MEMS chip 13 held in the first sound guide space SP1. In other words, the microphone unit 1 is configured as a differential microphone unit.

The distance over which an external sound travels from the first opening 18 to the diaphragm 134 through the first sound guide space SP1 and the distance over which an external sound travels from the second opening 19 to the diaphragm 134 through the second sound guide space SP2 are preferably designed such that the distances are substantially equal to each other, with the result that the time period during which the external sound travels from the first opening 18 to the diaphragm 134 through the first sound guide space SP1 is equal to the time period during which the external sound travels from the second opening 19 to the diaphragm 134 through the second sound guide space SP2. The microphone unit 1 of the present embodiment is configured as described above.

The microphone unit 1 configured as described above has excellent far noise suppression performance as with the previously developed microphone unit 100. Although, in the previously developed microphone unit 100, the far noise suppression performance is disadvantageously degraded in a high-frequency band, this problem is solved in the microphone unit 1 of the present invention. This will be described below.

In the microphone unit 1 of the present embodiment, the first sound guide space SP1 and the second sound guide space SP2 differ in shape and volume. This point is the same as in the previously developed microphone unit 100. However, in the microphone unit 1, the configuration of the mounting portion 11 on which the MEMS chip 13 is mounted differs from that of the previously developed microphone unit 100. This difference allows the microphone unit 1 to achieve satisfactory far noise suppression performance even in a high-frequency band.

In the present embodiment, the volume of the first sound guide space SP1 is about 5 mm³, and the volume of the second sound guide space SP2 is about 2 mm³.

As described above, it is thought that the reason why, in the previously developed microphone unit 100, it is impossible to obtain satisfactory far noise suppression performance in high frequencies is because the frequency characteristic when the sound wave travels through the first sound guide space SP1 differs from the frequency characteristic when the sound wave travels through the second sound guide space SP2. In other words, it is thought that the frequency characteristic when the sound wave travels through the sound guide space SP1 and the frequency characteristic when the sound wave travels through the sound guide space SP2 are equalized, and thus it is possible to obtain satisfactory far noise suppression performance in high frequencies.

Hence, the inventors of the present application consider that the structure of the conventional microphone unit 100 is improved to make the resonance frequencies of the two sound guide spaces SP1 and SP2 close to each other, and thus the frequency characteristic when the sound wave travels through the first sound guide space SP1 and the frequency characteristic when the sound wave travels through the second sound guide space SP2 are equalized. The reason why the conventional structure is improved to equalize the frequency characteristic when the sound wave travels through the sound guide space SP1 and the frequency characteristic when the sound wave travels through the sound guide space SP2 is because it is considered that a microphone unit is provided in which the effects of the dust (generated from the sound resistance members) are unlikely to produce a failure in the MEMS chip.

The first sound guide space SP1 probably behaves like a known Helmholtz resonator because of its shape. Hence, the resonance frequency fr of the first sound guide space SP1 is probably given by formula (2) below. In formula (2), Cv is a sound speed, S is the area of the first opening 18 (the cross-sectional area of the through hole 121), Lp is the thickness (the length of the hole) of the through hole 121 provided in the cover 12, ΔL is opening end correction and V is the volume of the holding space 123.

$$\begin{matrix}[ Formula 1 ] & \\ fr = \frac{Cv}{2 π} √ \frac{S}{( Lp + Δ L ) \cdot V )} & ( 2 )\end{matrix}$$

As is understood from formula (2), the resonance frequency of the first sound guide space SP1 can be changed by varying at least one of the volume of the holding space 123, the area of the first opening 18 and the thickness of the through hole 121. On the other hand, since the shape of the second sound guide space SP2, probably, is completely different from the Helmholtz resonator, the resonance frequency, probably, cannot be simply represented by formula (2).

As a result of performing intensive research with consideration given to a request for reducing the size of the microphone unit, the ease of manufacturing and the like, it is found that the following improvement is preferably performed when the microphone unit 100 is improved. Specifically, it is found that, within the second sound guide space SP2 (in an inward side away from the second opening 19), a cross-sectional area reduction portion is provided that locally reduces, as compared with forward and backward portions thereof, an area of a sound path cross section substantially perpendicular to the direction in which the sound wave travels, and thus it is possible to make close to each other the frequency characteristic (resonance frequency) when the sound wave travels through the sound guide space SP1 and the frequency characteristic (resonance frequency) when the sound wave travels through the sound guide space SP2.

The examination described above is performed so that the resonance frequencies of the two sound guide spaces SP1 and SP2 are prevented from being excessively lowered (prevented from being lowered than at least 10 kHz). This is because, when the resonance frequencies of the two sound guide spaces SP1 and SP2 are excessively lowered, the frequency characteristic of the microphone does not become flat in the usage frequency range, with the result that the performance of the microphone unit 1 is reduced.

In the microphone unit 1 of the present embodiment, the cross-sectional area reduction portion AR described above is provided in the mounting portion 11. More specifically, the cross-sectional area reduction portion AR is formed with the three through holes 111b, 111c and 111d (see FIG. 2A) that form the three second mounting portion openings 16 provided in the mounting portion 11. Although, as described above, the second mounting portion openings 16 are formed with the three openings, the total of the areas of these (the areas of the individual openings) is less than the cross-sectional area (that is, the cross-sectional area of the through hole 122 provided in the cover 12) in the position in front of it. Hence, in the second sound guide space SP2, in the position in which the second mounting portion openings 16 are provided, the area (sound path cross-sectional area) of the cross section substantially perpendicular to the direction in which the sound wave travels is reduced.

The second mounting portion openings 16 (three openings) are obtained, as described above, by the through holes 111b, 111c and 111d formed in the first flat plate 111 of the mounting portion 11; in the microphone unit 1, the sound path cross-sectional area is reduced (that is, locally) by the lengths (thicknesses) of these three through holes 111b to 111d.

In the previously developed microphone unit 100, only one second mounting portion opening 101b is provided, and has the same shape and size as the first opening 102b (see FIGS. 10A to 10C); within the second sound guide space SP2, the configuration in which the sound path cross-sectional area is locally reduced is not adopted. With respect to this point, in the microphone unit 1 of the present embodiment, the second mounting portion opening is improved, and thus, within the second sound guide space SP2, the cross-sectional area reduction portion AR for locally reducing the sound path cross-sectional area is provided. Thus, as shown in FIG. 7, it is possible to lower the resonance frequency of the second sound guide space SP2 as compared with the previously developed microphone unit 100 and thereby equalize such resonance frequency and the resonance frequency of the first sound guide space SP1. Consequently, it is possible to make the resonance frequencies of the first sound guide space SP1 and the second sound guide space SP2 close to each other and thereby equalize the frequency characteristics of both spaces, with the result that the microphone unit 1 has satisfactory far noise suppression performance even in a high-frequency band (in a wide frequency band).

Here, FIG. 7 is a graph showing a frequency characteristic when, in the microphone unit of the first embodiment, only either of the first sound guide space and the second sound guide space is used. FIG. 7 is the graph that is similar to that of FIG. 13 described previously; the frequency characteristic is obtained by performing the same method as in FIG. 13. In FIG. 7, the graph (a) represented by a solid line shows the frequency characteristic when only the first sound guide space SP1 of the microphone unit 1 is used, and the graph (b) represented by a broken line shows the frequency characteristic when only the second sound guide space SP2 of the microphone unit 1 is used.

Preferably, to what degree the cross-sectional area is reduced by the cross-sectional area reduction portion AR and to what degree of range the cross-sectional area is reduced by the cross-sectional area reduction portion AR are determined as necessary by experiments and the like so that the frequency characteristics of the first sound guide space SP1 and the second sound guide space SP2 are equalized.

Although, in the present embodiment, the second mounting portion openings 16 are formed with the three openings, the present invention is not intended to be limited to this configuration. As long as the purpose of reducing the area (sound path cross-sectional area) of the cross section substantially perpendicular to the direction in which the sound wave travels is satisfied, the number of openings constituting the second mounting portion openings 16 may be changed as necessary, may be one depending on the situation or may be two or more other than three. When the number of openings constituting the second mounting portion openings 16 is excessively increased, a problem in which the workability of manufacturing is degraded or the like may be produced; preferably, the number of openings is not excessively increased. As long as the purpose of reducing the area (sound path cross-sectional area) of the cross section substantially perpendicular to the direction in which the sound wave travels is satisfied, the shape of the second mounting portion openings 16 can be changed as necessary.

### (Microphone Unit According to a Second Embodiment of the Present Invention)

The microphone unit of a second embodiment has the same configuration as the microphone unit 1 of the first embodiment except the configuration of the mounting portion 11. Only different points will be described below. In the following description, portions in common with the first embodiment are identified with the same symbols.

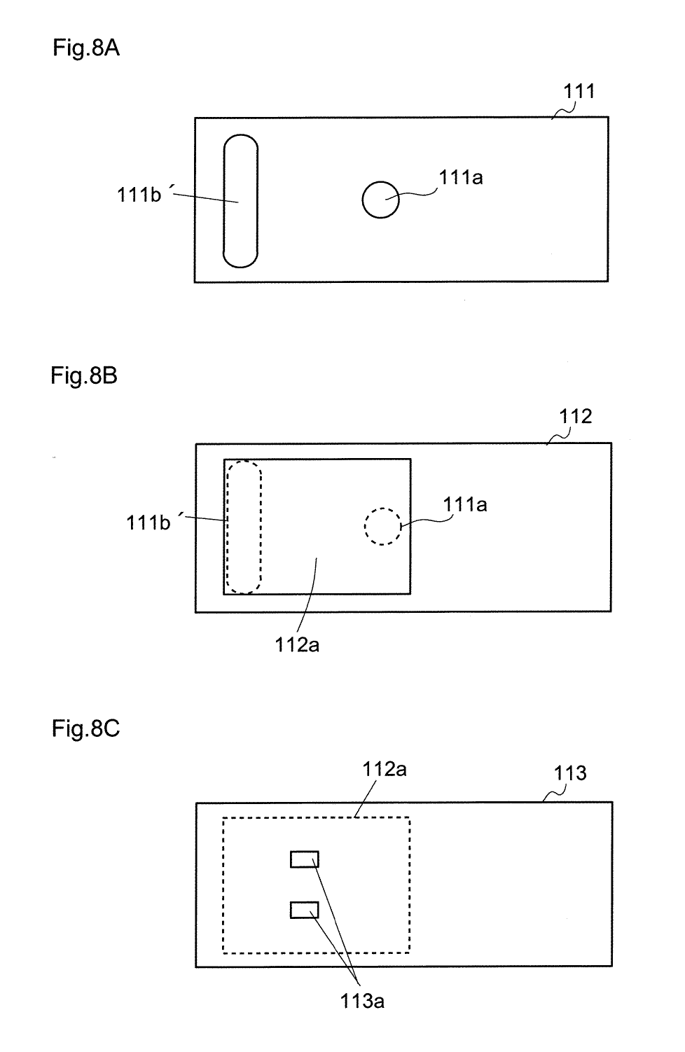

FIGS. 8A, 8B and 8C are schematic plan views showing three flat plates forming the mounting portion included in the microphone unit of the second embodiment; FIG. 8A is a top view of a first flat plate; FIG. 8B is a top view of a second flat plate; FIG. 8C is a top view of a third flat plate. As is understood from FIGS. 8A, 8B and 8C, the point in which the mounting portion 11 is formed with the three flat plates 111, 112 and 113 is the same as in the first embodiment. The shapes, sizes and materials of the three flat plates 111, 112 and 113 forming the mounting portion 11 are also the same as in the first embodiment.

In the first flat plate 111, as in the first embodiment, the through hole 111a formed substantially in the shape of a circle as seen in plan view is provided in the vicinity of the center thereof. In the first flat plate 111, a through hole 111b′ that is formed substantially in the shape of a rectangle (substantially stadium-shaped) as seen in plan view is provided close to one end in the longitudinal direction (close to the left end of FIG. 8A). In the cross section of the through hole 111b′ formed substantially in the shape of a rectangle as seen in plan view, the length in the longitudinal direction (the up/down direction of FIG. 8A) is 2 mm, and the length in the widthwise direction (the left/right direction of FIG. 8A) is 0.5 mm. The size described above is equal to the size of the cross section of the through hole 122 provided in the cover 12; in this point, the configuration is different from that of the first embodiment but is the same as in the previously developed microphone unit 100 (see FIGS. 10A to 10C).

In the second flat plate 112, as shown in FIG. 8B, the through hole 112a (whose upper surface and lower surface have the same shape and size) formed substantially in the shape of a rectangle as seen in plan view is provided. The through hole 112a formed substantially in the shape of a rectangle as seen in plan view is provided such that, with the second flat plate 112 and the first flat plate 111 stacked, the through hole 111a that is provided in the first flat plate 111 and that is formed substantially in the shape of a circle as seen in plan view and the through hole 111b′ that is formed substantially in the shape of a rectangle as seen in plan view fall within the region thereof. For ease of understanding of the relationship between the first flat plate 111 and the second flat plate 112, in FIG. 8B, the through holes 111a and 111b′ provided in the first flat plate 111 are represented by broken lines.

In the third flat plate 113, as shown in FIG. 8C, two protrusion portions 113a are provided a predetermined distance apart in the widthwise direction. The two protrusion portions 113a may be provided integrally with the third flat plate 113 or may be provided as members other than the third flat plate 113. When they are provided as the members other than the third flat plate 113, the protrusion portions 113a are preferably fixed to the third flat plate 113 with, for example, an adhesive. Broken lines in FIG. 8C represent the through hole 112a provided in the second flat plate 112 stacked on the third flat plate 113. As is understood from this, with the third flat plate 113 stacked on the second flat plate 112, the two protrusion portions 113a are surrounded by the through hole 112a provided in the second flat plate 112.

The first flat plate 111, the second flat plate 112 and the third flat plate 113 configured as described above are adhered, and thus it is possible to obtain the mounting portion 11 in which the first mounting portion opening 15 obtained by the through hole 111a, a second mounting portion opening 16 (one opening, which is different from the first embodiment) obtained by the through hole 111b′ and the mounting portion internal space 17 connecting the first mounting portion opening 15 and the second mounting portion opening 16 are formed.

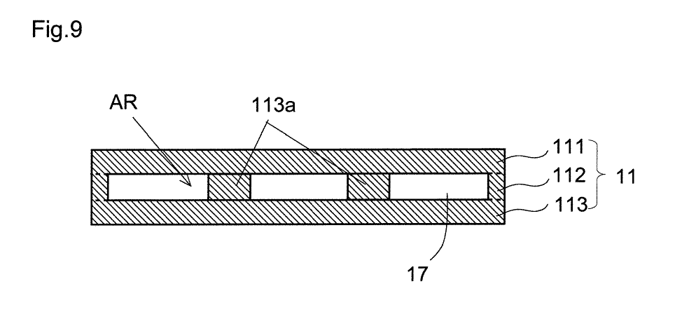

FIG. 9 is a cross-sectional view of the mounting portion included in the microphone unit of the second embodiment. As shown in FIG. 9, the height of the protrusion portions 113a provided in the third flat plate 113 is equal to the thickness of the second flat plate 112. Hence, with the three flat plates 111 to 113 adhered to each other, the protrusion portions 113a are, as shown in FIG. 9, in contact with the lower surface of the first flat plate 111. By the presence of the protrusion portions 113a described above, in the mounting portion internal space 17 formed in the mounting portion 11, the area (sound path cross-sectional area) of a cross section substantially perpendicular to the direction in which the sound wave travels is locally reduced.

In other words, in the microphone unit of the second embodiment, the cross-sectional area reduction portion AR is not formed by utilizing the second mounting portion opening 16 but is formed with protrusion portions 113a provided in the mounting portion internal space 17. With reference to FIG. 8C, the amount of decrease in the sound path cross-sectional area can be adjusted by the length (the length in the up/down direction of FIG. 8C) of the protrusion portions 113a in the lengthwise direction, and the range of local reduction in the sound path cross-sectional area can be adjusted by the length (the length in the left/right direction of FIG. 8C) of the protrusion portions 113a in the lateral direction. These lengths are preferably determined as necessary by experiments and the like so that the frequency characteristics of the first sound guide space SP1 and the second sound guide space SP2 are equalized.

In this configuration, as is understood with reference to FIG. 9, the cross-sectional area reduction portion AR is said to be formed with a plurality of through holes. This is because the three spaces that can be formed by separating the mounting portion internal space 17 with the two protrusion portions 113a can be individually regarded as the through holes.

In the present embodiment, it is also possible to lower the resonance frequency of the second sound guide space SP2 as compared with the previously developed microphone unit 100, with the result that it is possible to make the resonance frequencies of the first sound guide space SP1 and the second sound guide space SP2 close to each other and thereby equalize the frequency characteristics of both spaces. Hence, in the microphone unit of the present embodiment, it is possible to obtain satisfactory far noise suppression performance in a wide frequency band.

The shape of the protrusion portions 113a is not limited to the configuration of the present embodiment; as long as it is possible to obtain the cross-sectional area reduction portion AR, another shape may be naturally adopted. The number of protrusion portions 113a can be naturally changed as necessary. Furthermore, in order for the cross-sectional area reduction portion AR to be obtained, the position of the protrusion portions 113a may be naturally displaced from the configuration of the present embodiment.

(Others)

The microphone units described in the embodiments discussed above are simply illustrative of the present invention; the scope of the present invention is not limited to the embodiments discussed above. In other words, various modifications are possible in the embodiments described above without departing from the object of the present invention.

For example, although, in the embodiments described above, the cross-sectional area reduction portion AR is formed by utilizing the second mounting portion opening 16 of the mounting portion 11 on which the MEMS chip 13 is mounted, the cross-sectional area reduction portion AR may be provided by using the first mounting portion opening 15. Although, in both the first embodiment and the second embodiment described above, the cross-sectional area reduction portion AR is provided in the mounting portion 11, the cross-sectional area reduction portion may be provided in the cover 12.

Although, in the embodiments described above, the MEMS chip 13 and the ASIC 14 are individually formed with a separate chip, an integrated circuit mounted in the ASIC 14 may be monolithically formed on a silicon substrate forming the MEMS chip 13. In other words, the MEMS chip 13 and the ASIC 14 may be integrally formed. Although, in the embodiments described above, the ASIC 14 is held within the enclosure 10, the ASIC 14 may be provided outside the enclosure 10.

Although, in the embodiments described above, the electroacoustic conversion element converting the sound pressure into the electrical signal is the MEMS chip 13 formed by utilizing a semiconductor manufacturing technology, the present invention is not intended to be limited to this configuration. For example, the electroacoustic conversion element may be a capacitor microphone using an electret film or the like.

In the embodiments described above, a so-called capacitor microphone is adopted as the configuration of the electroacoustic conversion element (corresponding to the MEMS chip 13 of the present embodiment) included in the microphone unit. However, the present invention can also be applied to a microphone unit that adopts a configuration other than a capacitor microphone. For example, the present invention can also be applied to a microphone unit that adopts, for example, an electrodynamic (dynamic), electromagnetic (magnetic) and piezoelectric microphone.

### INDUSTRIAL APPLICABILITY

The microphone unit of the present invention is suitable for sound communication devices such as a mobile telephone and a transceiver, information processing systems (such as a sound authentication system, a sound recognition system, a command generation system, an electronic dictionary, a translator and a remote controller of a sound input system) that adopt a technology for analyzing an input sound, recording devices, amplifier systems (loudspeaker), microphone systems and the like.

### LIST OF REFERENCE SYMBOLS

1 microphone unit
10 enclosure
11 mounting portion
12 cover
13 MEMS chip (electroacoustic conversion element)
14 ASIC (electrical circuit portion)
15 first mounting portion opening
16 second mounting portion opening
17 mounting portion internal space
18 first opening
19 second opening
111b, 111c, 111d a plurality of through holes (forming across-sectional area reduction portion)
121 through hole (first through hole)
122 through hole (second through hole)
123 concave•holding space
134 diaphragm
AR cross-sectional area reduction portion
SP1 first sound guide space
SP2 second sound guide space

1. A microphone unit comprising:
an electroacoustic conversion element that converts a sound signal into an electrical signal based on vibration of a diaphragm; and
an enclosure that holds the electroacoustic conversion element,
wherein a first sound guide space holding the electroacoustic conversion element and a second sound guide space separated by the diaphragm from the first sound guide space are provided in the enclosure,
the first sound guide space guides a sound wave from outside the enclosure to one surface of the diaphragm through a first opening formed in an external surface of the enclosure,
the second sound guide space guides a sound wave from the outside the enclosure to the other surface of the diaphragm through a second opening formed in the external surface of the enclosure and
in an inward side of the second sound guide space apart from the second opening, a cross-sectional area reduction portion is provided that locally reduces, as compared with forward and backward portions thereof, an area of a sound path cross section substantially perpendicular to a direction in which the sound wave travels.

2. The microphone unit of claim 1,
wherein the second sound guide space has a shape different from a shape of the first sound guide space, and
the first opening and the second opening are formed in the same external surface of the enclosure.

3. The microphone unit of claim 1,
wherein the cross-sectional area reduction portion is formed with a plurality of through holes.

4. The microphone unit of claim 1,
wherein the enclosure includes a mounting portion on which the electroacoustic conversion element is mounted, the mounting portion having a first mounting portion opening covered by the electroacoustic conversion element, a second mounting portion opening formed in the same surface where the first mounting portion opening is formed, and a mounting portion internal space connecting the first mounting portion opening and the second mounting portion opening, and
a cover which is placed on the mounting portion to cover the electroacoustic conversion element, the cover having a holding space in which the electroacoustic conversion element is held, a first through hole of which one end is connected to the holding space and the other end is connected to the outside of the cover, and a second through hole which is not connected to the holding space and of which one end is connected to the second mounting portion opening and the other end is connected to the outside of the cover,
the first sound guide space is formed with the first through hole and the holding space,
the second sound guide space is formed with the second through hole, the first mounting portion opening, the second mounting portion opening and the mounting portion internal space, and
the cross-sectional area reduction portion is provided in the mounting portion.

5. The microphone unit of claim 4,
wherein the second mounting portion opening is formed with a plurality of openings such that a total area of the plurality of openings is less than a cross-sectional area of the second through hole, and
the cross-sectional area reduction portion is formed with a plurality of through holes forming the plurality of openings.

6. The microphone unit of claim 1,
wherein an electrical circuit portion that processes an electrical signal obtained from the electroacoustic conversion element is held within the first sound guide space.
